(19) United States
(12) Patent Application Publication
(10) Pub. No.: US 2007/0012341 A1
(43) Pub. Date: Jan. 18, 2007

(54) SUPERCRITICAL FLUID DELIVERY SYSTEM FOR SEMICONDUCTOR WAFER PROCESSING

(76) Inventors: Stephen B. Douglas, Boxborough, MA (US); Rick C. White, Nashua, NH (US); Keith R. Pope, Danbury, CT (US); David J. Mount, North Andover, MA (US); Heiko D. Moritz, Milford, NH (US)

Correspondence Address: MAINE & ASMUS, 100 MAIN STREET, P O BOX 3445, NASHUA, NH, 03061-3445, US

(21) Appl. No.: 11/468,840

(22) Filed: Aug. 31, 2006

Related U.S. Application Data
(62) Division of application No. 10/634,458, filed on Aug. 5, 2003.
(63) Continuation-in-part of application No. 09/837,507, filed on Apr. 18, 2001, now Pat. No. 6,612,317.
Application No. 10/634,458 is a continuation-in-part of application No. 09/861,298, filed on May 18, 2001, now Pat. No. 6,602,349.
Application No. 09/861,298 is a continuation-in-part of application No. 09/837,507, filed on Apr. 18, 2001, now Pat. No. 6,612,317.
(60) Provisional application No. 60/197,519, filed on Apr. 18, 2000.
(60) Provisional application No. 60/267,916, filed on Feb. 9, 2001.
(60) Provisional application No. 60/205,335, filed on May 18, 2000.

(51) Int. Cl. B08B 3/00

(52) U.S. Cl. 134/50; 134/111

(57) ABSTRACT

An elevated pressure and temperature fluid processing system providing a pressurized fluid delivery system including a process fluid supply system and pump for supplying a process fluid at a process pressure, and a process fluid heater for heating the process fluid; a process chamber with a process chamber heater; and a process discharge collection system. The system also provides a process chamber inflow valve for connecting the pressurized fluid delivery system to the process chamber for fluid flow, and a process chamber outflow valve for connecting the process chamber to the collection system for fluid flow. A process chamber bypass valve connects the pressurized fluid delivery system to the process discharge collection system so as to bypass the process chamber. A computer control system controls the pump, the process fluid heater, the chamber heater, and the valves.

### RELATED APPLICATIONS

This application is a divisional of U.S. application Ser. No. 10/634,458, filed Aug. 5, 2003, which is a continuation-in-part of U.S. application Ser. No. 09/837,507, filed Apr. 18, 2001 (U.S. Pat. No. 6,612,317, issued Sep. 2, 2003), which is a non-provisional application claiming the benefit of U.S. Provisional Application Nos. 60/197,519, filed Apr. 18, 2000 and 60/267,916, filed Feb. 9, 2001. U.S. application Ser. No. 10/634,458, filed Aug. 5, 2003 is also a continuation-in-part of U.S. application Ser. No. 09/861,298, filed May 18, 2001 (U.S. Pat. No. 6,602,349, issued Aug. 5, 2003), which is a continuation-in-part of U.S. application Ser. No. 09/837,507, filed Apr. 18, 2001 (U.S. Pat. No. 6,612,317, issued Sep. 2, 2003). U.S. application Ser. No. 09/861,298, filed May 18, 2001 (U.S. Pat. No. 6,602,349, issued Aug. 5, 2003), is a non-provisional application claiming the benefit of U.S. Provisional Application No. 60,205,335, filed May 18, 2000. Each of these applications is herein incorporated in its entirety by reference.

### FIELD OF THE INVENTION

The invention relates to fluid delivery systems for processing and cleaning various devices with high pressure and temperature fluids, particularly to fluid delivery systems servicing a pressure vessel for supercritical phase cleaning and processing of semiconductor wafers and other such devices, as for removal of solvents, photo-resist materials, and loose particulate matter.

### BACKGROUND OF THE INVENTION

The benefits of using supercritical fluids for cleaning and treating various mechanical and electrical components are well understood in the art. A number of patents have been granted that included pressure vessels and fluid delivery and recovery systems for the associated fluids, as well as compositions of process fluids and methods for supercritical use.

Published works refer to treating semiconductor wafers with supercritical fluids, with and without co-solvents or surfactants, to clean, strip solvents or photo-resist resins, dehydrate, or otherwise treat the wafers or structures on the wafers. The processes are necessarily batch operated due to the high pressures and temperatures required. A sample or unit portion of the materials under process, such as a single semiconductor wafer, is sealed in a pressure vessel plumbed for receiving a process fluid flow. The process is then conducted to completion and the vessel opened for reloading.

The extent to which these processes or treatments are successful in commercial practice depends in large part on the user's ability to optimize the potential of the selected process fluids and available co-solvents and other additives by controlling the related process variables within the users control, mainly the temperatures, pressures, mixing ratios and fluid dynamics by which the process fluid or mixture is placed in contact with the object under process.

Ideally, continuous flow, steady-state operation of a supercritical fluid-handling system is desirable for stable process control, but some processes require that some time be allocated at the beginning or end or some point in the middle of the operation for discontinuous or un-steady state flow functions such as mixing, heating, cooling, pumping to fill and empty vessels, and increasing or decreasing system pressures.

Semiconductor wafer processing in a manufacturing environment involves multiple batch operations with high cycling rates. The repetitive sequence of process operations may be automated by robot manipulation of wafers in enclosed environments, such as “cluster-tools”, which interface to a number of process locations. Such automated systems require frequent loading and unloading of wafer process equipment, and require rapid cycling of pressures and temperatures in the process chambers if supercritical fluids are to be used.

Process chamber bypass lines providing for continuous fluid flow in the system whether or not the chamber is “on-line” provides for process fluids being immediately available at the supercritical state for admission into the chamber, as was disclosed in parent application Ser. No. 09/837507, filed Apr. 18, 2001, which is incorporated by reference herein for all purposes. However, if the system is idling during the period where the process chamber is not being fed or bled by the process fluid stream, it is inefficient to bypass the chamber with the mixed fluid stream for relatively extended periods of time and then process the unused fluid mixture to separate or otherwise recover the constituent components whether for disposal, recycle or other uses.

Solvents, specifically CO₂, are typically pumped in their liquid state to charge a cleaning apparatus or to circulate them in the apparatus. In their gaseous state, solvents are difficult to pump and the pump capacity or mass flow rate diminishes significantly. If the temperature of the CO₂ residing in the pump and charging system increases as a result of the CO₂ absorbing heat from the environment, the CO₂ will develop a gas phase. This development of a gas phase is to be avoided. It is for this reason that the temperature of both inlet flow streams of carbon dioxide and the pump head are sub-cooled to a temperature that prevents evaporation of the CO₂. When heat is added during the pumping operation, the fluid must, at any given pressure, remain below the temperature at which it vaporizes.

Conversely, if liquid carbon dioxide that has been cooled remains static in a tube that is not actively cooled it may eventually reach equilibrium temperature with the environment with CO₂ present in both the gas and the liquid phase. Therefore, in any liquid carbon dioxide system, it is desirable to keep the fluid in circulation and continuously being cooled. Once the pump is primed with liquid fluid and the cooling system running, the pump is most efficient if it can remain operating. Previously cooled, stagnant fluid can only heat up, and once the gas phase develops it can be difficult to prime the pump and then recommence operation.

With respect to the use of co-solvents with carbon dioxide in the supercritical fluid processing of materials, there is recognized an ability to widely vary the capability of the fluid to process material through the variation of the concentration of additives. In any given case the fluid mixture is brought to thermodynamic and physical equilibrium before the processing of material can be reproducibly applied. In the mixing process, a number of schemes are known to be effective. The many examples, familiar to those skilled in the art, include separate physical mixing in a separate chamber prior to processing, and so-called in-line mixing or static mixing in which the momentum of the flowing fluids is utilized to provide the energy necessary for physical mixing by impingement upon tortuous paths which convert forward momentum into transverse or turbulent movement.

However, the time constraint on certain processes, especially for semiconductor processes, limits the amount of time available for mixing and may in certain cases require that mixing occur on the same timescale as the immediate transfer of fluid by the most direct possible plumbing path. Thus, attention must be paid to all details of the mixing conditions.

### BRIEF SUMMARY OF THE INVENTION

In applications where CO₂ is used as a cleaning agent it is applied either in its liquid or supercritical state. In order to provide appropriate chemistry for the desired cleaning task, additives are often mixed with the CO₂. The goal is to achieve a homogeneous mixture within the period of time that the cleaning task demands. Which method of mixing is applied depends on the chemical and physical properties of the agents, the CO₂ and the additive/s, and has to be chosen with care. One embodiment of the present invention relates to the relationship between temperature and density of the co-solvent or additives and the process fluid, normally carbon dioxide (CO2), at the pressure where processing, and thus mixing, must be done. If the temperatures are the same, then there will subsequently be a minimum of heat transfer that occurs between the fluids during the passage through a static mixer mixing stage and introduction to the processing chamber. However, under circumstances where rapid mixing occurs, it may be advantageous to introduce the co-solvent at a different temperature than the CO₂ if the densities will be more closely matched. As the fluids of similar density contact each other, the volume element of similar density will be more quickly combined, with subsequent thermal transfer occurring during the movement of the fluid mixture through the system to the chamber for processing. If the densities and viscosities of the fluids are different at the point of combination, even though the temperatures are the same, the mixing will be limited by the rate at which momentum transfer can occur.

If the densities and viscosities are more closely matched, the rate of mixing will be limited by the rate of thermal equilibration. In general, these rates are not equivalent, and the difference depends on the density and viscosity functions of the fluids as a function of time. The behavior of fluids mixing under these conditions is governed at some point by non-equilibrium thermodynamics, and this can be used to one's advantage in designing a system, which processes materials as rapidly as possible. For example, at 3000 psi, the densities of the solvents CO₂ and heptane are quite different at 40 degrees Centigrade. However, the densities of CO₂ and heptane are very similar at 70° C. Thus, it may be advantageous to mix the solvents at one density and temperature, and then thermally re-equilibrate at the desired process temperature.

Therefore, one aspect of the present invention connects a process fluid supply system with suitable pressure and temperature control devices to a process fluid pressure vessel which is configured with a bypass line so that the process fluid, properly mixed and equilibrated, can be flowed through the bypass line until the fluid is at the desired pressure and temperature and otherwise in condition for admission into the chamber.

Another aspect of the present invention includes a process fluid supply system with suitable pressure and temperature control devices and an additive supply system similarly configured, combined into a total supply system for mixing additives to the process fluid; where both the process fluid and the additives are brought to respective pre-process pressures and temperatures for optimal mixing densities or such other state or condition that facilitates mixing so as to achieve a homogenous mixture. The system may provide thereafter for elevating the temperature of the mixture further to the desired final process temperature.

The total supply system above may be utilized with a pressure vessel and bypass or shunt line, providing a bypass of mixture flow around the chamber until the mixture is at the desired state or condition for admission into the chamber for processing.

A collection system may provide separation capabilities for separating phases and constituents of the process discharge, and may provide for reclamation for other uses or return lines for reclaimed process fluid or additives that can be reused at the supply side of the system.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a supercritical fluid delivery system configured in accordance with one embodiment of the present invention.

### DETAILED DESCRIPTION OF THE INVENTION

The invention is capable of numerous embodiments, what follows being merely one embodiment and thereby not limiting of the scope of the invention as claimed. Also, the illustration and explanations are directed only to the relevant features of the apparatus and methods necessary to a clear understanding of the invention. Those skilled in the art will appreciate that high pressure and high temperature systems are generally required to meet strict regulatory and safety standards, and will necessarily employ more sophisticated sensors and controls than are depicted in the simplified descriptions that follow.

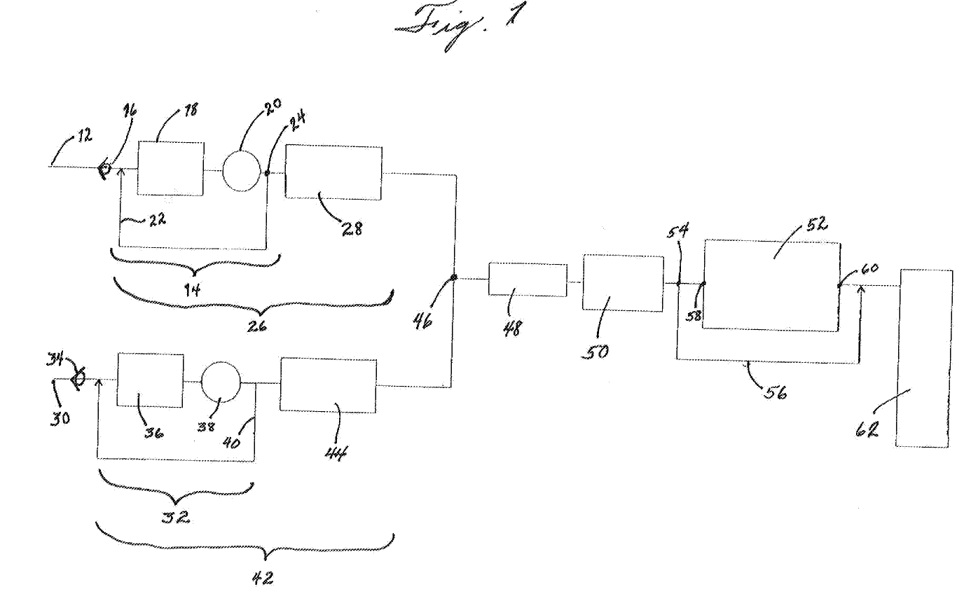

FIG. 1 illustrates the basic components of a supercritical fluid delivery system configured in accordance with one embodiment of the present invention. A process fluid source 12 is coupled to a process fluid supply system 14. In one embodiment, this coupling is achieved by a check valve 16, which allows the introduction of the fluid into the process fluid supply system 14 without process fluid flowing back into the process fluid source 12. The process fluid supply system 14 receives the process fluid, which according to one embodiment is carbon dioxide (CO₂). The process fluid may be directed through a heat exchanger cooled by a chiller or other such temperature control device 18, which insures that the fluid is in the liquid phase and not a gas or supercritical phase which might reduce pumping efficiency. The liquid phase fluid is passed through a pump 20. This pump 20 pumps the process fluid into a closed volume or through a restrictive device, thereby increasing the pressure of the process fluid to at least the desired process pressure.

According to one embodiment, the process fluid supply system 14 is also provided with a re-circulation loop 22. As noted above, process fluids, particularly carbon dioxide, if static, will seek an equilibrium between the gas and liquid phases, rather than remaining in the liquid phase. As the density of a gas phase fluid is substantially less than that of a liquid phase fluid, the presence of gas phase fluid will result in poor pump performance. According to one embodiment, a valve 24 disposed after the pump may be manipulated thereby redirecting the fluid from entering the process line into the re-circulation loop 22. The re-circulation loop 22 directs the fluid back to the heat exchanger 18, re-condensing any gas phase fluid, and through the pump 20. The fluid is thus maintained in the liquid state. When fluid is required, the fluid may be redirected back into the process line and is thereby supplied to the system. Other and various embodiments of present invention may include additional components disposed in the re-circulation loop 22, including but not limited to pressure relief valves, rupture disks, and resistance valves.

As illustrated in FIG. 1, the process fluid supply system 14 is one component in a process fluid delivery system 26. The process fluid delivery system 26 also comprises a process fluid heater 28.

According to one embodiment, a co-solvent or other additive or additive mixture may be introduced into the process fluid. A co-solvent source 30 supplies co-solvent to a co-solvent supply system 32 through a check valve 34. This system 32, according to one embodiment of the present invention, comprises a heat exchanger 36, a pump 38, and may include re-circulation loop 40 configured substantially like that in the process fluid supply system 14. Pump 38 elevates the pressure of the co-solvent to at least process pressure. Also similar to the process fluid supply system 14, the co-solvent supply system 32 is, according to one embodiment, one component in a larger system, a co-solvent delivery system 42. This co-solvent delivery system 42 may also include a co-solvent heater 44 for elevating the temperature of the co-solvent. As noted, the co-solvent described here may be replaced by other desired additives, or may be used in conjunction with other additives. Other embodiments may have multiple additive supply systems 42 configured in parallel so as to provide further options for different additives or combinations of additives to be available for conducting the process.

According to one embodiment, the co-solvent delivery system 42 and the process fluid delivery system 26 deliver their respective fluids to a directional valve 46 at pressures equal or exceeding the final process pressure. The respective heaters 44 of the co-solvent delivery system 42, and 28 of the process fluid delivery system 26, heat the respective co-solvent and process fluid to respective selected temperatures that bring the density or other condition of the co-solvent and the process fluid to an optimal match or proximity for mixing, thereby facilitating miscibility of the two fluids. The temperature of the co-solvent may equal that of the process fluid, or may be unequal. The temperatures may or may not be such that either or both of the process fluid and the co-solvent are elevated to supercritical phase. At the directional valve 46, the co-solvent is introduced to the process fluid, and the process fluid, now containing the co-solvent in a process fluid mixture is directed through at least one mixer 48 such that the process fluid mixture achieves a state suitable for conducting the intended process. One skilled in the art will readily appreciate that embodiments having either static or dynamic mixers are within the scope of the present invention.

According to the embodiment of the present invention illustrated in FIG. 1, after passage through a mixer 48, the fluid mixture is directed through a mixture heater 50. This mixture heater 50 raises the temperature of the fluid mixture to the desired process temperature. The process temperature may be high enough to induce a phase change in the process fluid mixture to a supercritical phase at the process pressure or to maintain supercritical phase at the process pressure. One skilled in the art would readily comprehend that other embodiments, also within the scope of the present invention, may omit this mixture heater 50 in favor of heating the process fluid and co-solvent separately to temperatures adequate to assure that the process fluid mixture is at a suitable final temperature for conducting the process. This suitable final temperature may or may not be such that the process fluid is in its supercritical state. Some processes may optimally take place with the fluid in the liquid or vapor phase.

The heaters 28, 44, and 50 employed here may be heat exchangers, liquid heaters, electric heaters, line or strip heaters, co-axial coiled heaters, or other such heaters. Care must be taken as heaters may contaminate the fluid or result in the combustion or explosion of flammable reagents. Computer control and balancing of the total heating requirement as between the first-in-line heaters, 28 and 44, and the mixture heater 50, permits optimal miscibility for mixing and optimal final temperature for conducting the process.

Once at the optimal fluid state and carrying the co-solvent, the process fluid mixture is directed toward the process chamber 52. A chamber bypass valve 54 and line 56 are provided in the system, whereby the process fluid or fluid mixture may be selectively switched to flow through the bypass or into the chamber. This bypass 56 permits the flow, temperature, phase and mixing of process fluid or fluid mixture to be adjusted and regulated without introducing the mixture into the process chamber until the mixture is stabilized to the extent required. In this way, a homogenous fluid mixture already flowing at the desired pressure and temperature, possibly in the supercritical phase, may be introduced into the process chamber 52.

As is well understood by those skilled in the art, other valves, check valves, and pressure regulating devices such as a restrictor in the bypass line and in other lines in the system, provide for balancing and controlling the direction of flow and the pressure drops throughout the system.

According to one embodiment, a chamber inflow valve 58 is provided to introduce the mixture into the process chamber. The process chamber 52 is also provided with an outflow valve 60, which provides a means of exhaust for spent process fluid. In one embodiment, the bypass 54 and chamber inflow valves 58 may be unified into a single, three-way valve, providing both functions. Likewise, in other embodiments, outflow valve 60 may be a three-way valve where the bypass line terminates, and in other embodiments various valves may be operated cooperatively.

The process chamber 52 may also be provided with a heater to insure stable temperature in the chamber during the process or during prolonged steps of the process. Both the process discharge outflow from the chamber and process fluid or fluid mixture expelled via the bypass empty into a discharge or collection system 62. In one embodiment, a series of separators may be provided as part of this collection system where noxious, hazardous, or aggressive constituents of the discharge are collected for disposal in accordance with applicable health, safety, and environmental regulations. Such a separation may be made through the manipulation of phase changes or other chemical or physical processes. According to one embodiment, environmentally benign reagents may be exhausted to the atmosphere when permitted by applicable health, safety, and environmental regulations. Collected commercially valuable reagents may be reused or recycled. One skilled in the art will readily appreciate that other embodiments including sophisticated recycling systems such as that disclosed in co-pending U.S. Non-Provisional application, Ser. No. 09/837507, filed Apr. 18, 2001, of which this is a Continuation-in-part, and which is hereby incorporated by reference for all purposes, may also be used, and are within the scope of the present invention.

One embodiment of the present invention provides an elevated pressure and temperature fluid processing system including: a pressurized fluid delivery system having a process fluid supply system and pump for supplying a process fluid at a pressure of at least a process pressure, and a process fluid heater for heating the process fluid. Such a system also provides a process chamber with a process chamber heater and a process discharge collection system. A process chamber inflow valve connects the pressurized fluid delivery system to the process chamber for fluid flow, while a process chamber outflow valve connects the process chamber to the collection system for fluid flow. A process chamber bypass valve is provided for connecting the pressurized fluid delivery system to the process discharge collection system so as to bypass the process chamber. A computer control system controls the pump, the process fluid heater, the chamber heater, and the valves.

Such a system may also provide a pressurized fluid delivery system with a process fluid re-circulation system. In such an embodiment, the pump functions continuously.

A process fluid re-circulation system, may according to one embodiment provide a first valve whereby the process fluid supply system and pump are isolated from the first process fluid heater and the chamber when the first valve is closed, a check valve disposed between the process fluid re-circulation system and a process fluid source, a temperature control device whereby the process fluid is maintained in a liquid phase, and a re-circulation loop whereby the process fluid in the liquid phase is directed through the temperature control device and the pump.

The process discharge collection system may further comprise a recovery volume connecting to the process chamber for receiving a rapid discharge of process reagents from the process chamber, and recovery volume control valves for selecting and de-selecting the recovery volume from the process discharge collection system, the recovery volume control valves being controlled by the computer control system. This is useful for rapid pressurization and depressurization of the process chamber to dislodge contaminants.

The chamber heater, according to one embodiment provides a heating subsystem with inflow and outflow lines connecting a source of a preheated heat transfer media to at least one heat exchanger in the process chamber and control valves for controlling the circulation of the preheated media through the heat exchanger, the control valves being controlled by the computer control system for achieving a desired heating effect within the chamber. Alternatively the heater may be an electrical resistance heater or such other thermally effective energy input devices as may be available.

As noted above, in one embodiment, the process fluid may be carbon dioxide and the process being a supercritical phase process for cleaning and processing devices chosen from the group of devices consisting of semiconductor wafers, masks, light emitting diodes, and disk drive components.

According to one embodiment, such a system provides a pressurized additive delivery system including an additives supply system and pump for supplying additives at a pressure of at least the process pressure, and an additives heater for heating the additives to a pre-process temperature suitable for mixing with said process fluid. A directional valve, mixer and mixture heater may be disposed between the process fluids heater, the chamber, and the additives heater. The additives heater, directional valve, and mixture heater are controlled by the computer control system. The pressurized fluid delivery system and the pressurized additives delivery system being connected to the directional valve such that a computer controlled ratio of process fluids and additives can be admitted into the mixer and heater at selected respective temperatures.

The pressurized additives delivery system may also provide an additive re-circulation system, and wherein the pump functions continuously. Such a re-circulation system may include a first valve whereby the additives supply system and pump are isolated from the additives heater and the mixer when the first valve is closed; a check valve disposed between the additives re-circulation system and an additives source; a temperature control device whereby the additives are maintained at a selected temperature; a re-circulation loop whereby the additives are directed through the temperature control device and the pump.

The process discharge collection system may also include at least one separator for separating phases and constituents from the process discharge. A return line may connect the collection system to the pressurized fluid delivery system or to the pressurized additives delivery system.

According to one embodiment, the additive heater, the process chamber heater, and the process fluid heater are each selected from the group of heaters consisting of heat exchangers and electric heaters.

Another embodiment of the present invention provides a system for the supply of elevated pressure and temperature fluid to a process system, that system having: a pressurized fluid delivery system including a process fluid supply system and pump for supplying a process fluid at a pressure of at least a process pressure, and a process fluid heater for heating the process fluid to a process fluid mixing temperature; a pressurized additives delivery system including an additives supply system and pump for supplying additives at a pressure of at least the process pressure, and an additives heater for heating the additives to a additive mixing temperature suitable for mixing with the process fluid; a directional valve, disposed between the process fluids heater, the additive heater and the process system, and the additives heater. The pressurized fluid delivery system and the pressurized additives delivery system are connected to the directional valve such that a computer controlled ratio of process fluids and additives can be admitted to the directional valve.

Such a system may also provide a mixer, that mixer being disposed between the directional valve and the process system. In one embodiment, that mixer is chosen from the group of mixers consisting of static and dynamic mixers. Such a system may also provide a mixture heater. The mixture heater is disposed between the mixer and the process system and heats said mixture to at least a process temperature. This process temperature, in one embodiment, induces a phase change in the process fluid from a liquid phase to a supercritical phase.

A shunt disposed between the mixer and the process system, for selectively diverting the process fluid and additives from the process system may also be provided. This shunt provides a means for diverting the process fluid and additive until the mixture is homogenous and in the appropriate phase for the process. The process fluid mixing temperature may be at least equal to a process temperature. The process fluid temperature, according to one embodiment induces a phase change in the process fluid from a liquid phase to a supercritical phase.

Another embodiment of the present invention provides a method for mixing additives to a process fluid in a high pressure and temperature fluid processing system having the steps of maintaining a supply of process fluid at a pressure of at least a process pressure in communication via a common conduit with a pressure vessel; maintaining a supply of additives in a fluid form at a pressure of at least the process pressure in communication with the pressure vessel via the common conduit; adjusting the temperature of the supply of process fluid for a first desired mixing temperature; adjusting the temperature of the supply of additives in fluid form for a second desired mixing temperature; and admitting respective flows from respective supplies of the process fluid and the additives at a selected ratio into the common conduit so as to have a mixture flowing in the common conduit.

The method may also include the step of adjusting the temperature of the mixture to a desired process temperature. This process temperature may induce a phase change in the process fluid from a liquid phase to a supercritical phase.

The method may also include the steps of arranging a bypass valve disposed in the common conduit for bypassing the pressure vessel; adjusting the bypass valve so as to direct the mixture into the pressure vessel when the mixture reaches the desired process temperature and a homogenous state.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An elevated pressure and temperature fluid processing system comprising:
a pressurized fluid delivery system including a process fluid supply system and pump for supplying a process fluid at a pressure of at least a process pressure, and a process fluid heater for heating said process fluid;
a process chamber with a process chamber heater; and
a process discharge collection system;
a process chamber inflow valve for connecting said pressurized fluid delivery system to said process chamber for fluid flow;
a process chamber outflow valve for connecting said process chamber to said collection system for fluid flow;
a process chamber bypass valve for connecting said pressurized fluid delivery system to said process discharge collection system so as to bypass said process chamber; and
a computer control system controlling said pump, said process fluid heater, said chamber heater, and said valves.

2. The system according to claim 1 wherein said pressurized fluid delivery system comprises a process fluid re-circulation system, and wherein said pump functions continuously.

3. The system according to claim 2 wherein said process fluid re-circulation system comprises:
a first valve whereby said process fluid supply system and pump are isolated from said first process fluid heater and said chamber when said first valve is closed;
a check valve disposed between said process fluid re-circulation system and a process fluid source;
a temperature control device whereby said process fluid is maintained in a liquid phase;
a re-circulation loop whereby said process fluid in said liquid phase is directed through said temperature control device and said pump.

4. The system according to claim 1, said process discharge collection system further comprising a recovery volume connecting to said process chamber for receiving a rapid discharge of process reagents from said process chamber, and recovery volume control valves for selecting and de-selecting said recovery volume from said process discharge collection system, said recovery volume control valves being controlled by said computer control system.

5. The system according to claim 1, said chamber heater comprising a heating subsystem with inflow and outflow lines connecting a source of a preheated heat transfer medium to at least one heat exchanger in said process chamber and control valves for controlling the circulation of said preheated heat transfer medium through said heat exchanger, said control valves being controlled by said computer control system for achieving a desired heating effect within said chamber.

6. The system according to claim 1, said process fluid being carbon dioxide.

7. The system according to claim 1, said process being a supercritical phase process for cleaning and processing devices chosen from the group of devices consisting of semiconductor wafers, masks, light emitting diodes, and disk drive components.

8. The system according to claim 1 further comprising:
a pressurized additives delivery system including an additives supply system and pump for supplying additives at a pressure of at least said process pressure, and an additives heater for heating said additives to a pre-process temperature suitable for mixing with said process fluid;
a directional valve and mixer disposed between said process fluids heater, said process chamber, and said additives heater;
said additives heater and said directional valve being controlled by said computer control system;
said pressurized fluid delivery system and said pressurized additives delivery system being connected to said directional valve such that a computer controlled ratio of process fluids and additives can be admitted into said mixer and heater at selected respective temperatures.

9. The system according to claim 8 further comprising:
a mixture heater;
said mixture heater being disposed between said mixer and said process chamber; and
said mixture heater heating said mixture to at least a process temperature.

10. The system according to claim 8 wherein said pressurized additives delivery system comprises an additives re-circulation system, and wherein said pump functions continuously.

11. The system according to claim 10 wherein said additives re-circulation system comprises:
a first valve whereby said additives supply system and pump are isolated from said additives heater and said mixer when said first valve is closed;
a check valve disposed between said additives re-circulation system and an additives source;
a temperature control device whereby said additives are maintained at a selected temperature;
a re-circulation loop whereby said additives are directed through said temperature control device and said pump.

12. The system according to claim 3, said process discharge collection system further comprising at least one separator for separating phases and constituents from the process discharge.

13. The system according to claim 12, further comprising a return line from said collection system to said pressurized fluid delivery system.

14. The system according to claim 12, further comprising a return line from said collection system to said pressurized additives delivery system.

15. The system according to claim 8 wherein said additive heater, said process chamber heater, and said process fluid heater are each selected from the group of heaters consisting of heat exchangers and electric resistance heaters.
